(19) United States
(12) Patent Application Publication
(10) Pub. No.: US 2016/0042722 A1
(43) Pub. Date: Feb. 11, 2016

(54) DYNAMIC LABEL ARRANGEMENT DEVICE, DISPLAY DEVICE, DYNAMIC LABEL ARRANGEMENT METHOD, AND DISPLAY METHOD

(71) Applicant: MITSUBISHI ELECTRIC CORPORATION, Tokyo (JP)

(72) Inventors: Ken MIYAMOTO, Chiyoda-ku (JP); Shoichiro KUBOYAMA, Chiyoda-ku (JP); Junya UJIIE, Chiyoda-ku (JP)

(73) Assignee: MITSUBISHI ELECTRIC CORPORATION, Tokyo (JP)

(21) Appl. No.: 14/782,442

(22) PCT Filed: Apr. 22, 2013
(86) PCT No.: PCT/JP13/61767

§ 371 Date: Oct. 5, 2015

(51) Int. Cl. G09G 5/377; G09G 5/38; G01C 21/36; G06F 17/30

(52) U.S. Cl. CPC G09G 5/377; G06F 17/30058; G09G 5/38; G01C 21/3697; G09G 2340/0464; G09G 2340/145

(57) ABSTRACT

A dynamic label arrangement device includes a label DB to store a set of labels, a display information DB to store information required for display of labels, a position calculator to specify a label to be displayed on a display screen from among the labels stored in the label DB, and a label display to display the label specified by the position calculator, and the position calculator determines an arrangeable range in which labels can be arranged on the basis of an arrangement change range offset stored in the display information DB, and, when the range of the display screen is changed, performs an arrangement change on a label which has become displaced outside the arrangeable range and which is stored in the above-mentioned label DB.

### FIELD OF THE INVENTION

The present invention relates to a dynamic label arrangement device that arranges labels, such as road name labels and building labels, on an on-screen map such as a map for car navigation.

### BACKGROUND OF THE INVENTION

A map display function used for conventional car navigation systems and so on includes a function of displaying labels each consisting of a character string at fixed positions. This function has the drawback of a part or all of a label being cut off depending on an area in which the label is displayed (referred to as a display area from here on), and its readability degrading (refer to FIG. 21).

To solve this problem, a method of changing the positions of labels in a 2D map to legible positions according to a change of the display area is disclosed (for example, patent reference 1). Further, a technique of displaying labels in a 3D map is also disclosed (for example, patent reference 2).

### RELATED ART DOCUMENT

### Patent Reference

Patent reference 1: Japanese Unexamined Patent Application Publication No. 2005-77428
Patent reference 2: Japanese Unexamined Patent Application Publication No. Hei 8-292715

### SUMMARY OF THE INVENTION

### Problems to be Solved by the Invention

A problem with the conventional technology as disclosed in patent reference 1 is, however, that because the conventional technology is targeted at road names and numbers in a 2D map (a map displayed in two dimensions), and is a method of displaying a road name and a road number at the center of the road accompanying these road name and number, when the method as disclosed in patent reference 1 is executed at a standard frame rate ranging from 10 fps to 60 fps in a car navigation system, the positions of the road name and number move frequently (refer to FIG. 22), and therefore their readability degrades.

Further, like in the case of 2D maps, also in a 3D map display function (a function of displaying a three-dimensional map, refer to FIG. 23), it is necessary to change the positions of labels to legible positions according to a change of the display area. A problem with this technique is that although display of labels in a 3D map is disclosed in, for example, patent reference 2, changing the positions of labels for each frame by using the configuration as disclosed in patent reference 2 results in frequent movements of the positions of the labels and degradation in their readability, like in the case of using the technique disclosed in patent reference 1.

The present invention is made in order to solve the above-mentioned problems, and it is therefore an object of the present invention to provide a dynamic label arrangement device, a dynamic label display device, and a dynamic label arrangement method that reduce the number of labels whose positions to be changed per frame, and maintain their readability, and a display method that displays dynamic labels which are arranged.

### Means for Solving the Problem

In accordance with the present invention, there is provided a dynamic label arrangement device including: a first label DB to store a set of labels each of whose position can be changed according to a change of a display area; a second label DB to store a set of labels each of whose position is not allowed to be changed; a third label DB to temporarily store a label to be displayed on a display screen and the position of the label; a display information DB to store information required for display of labels; a position calculator to specify a label to be displayed on the above-mentioned display screen from among the labels stored in the above-mentioned first label DB and the labels stored in the above-mentioned second label DB, and register the label in the above-mentioned third label DB; and a label display to display the label registered in the above-mentioned third label DB, in which the above-mentioned position calculator determines an arrangeable range in which labels can be arranged on the basis of an arrangement change range offset stored in the above-mentioned display information DB, and, when the range of the above-mentioned display screen is changed, performs an arrangement change on a label which has become displaced outside the above-mentioned arrangeable range and which is stored in the above-mentioned first label DB.

### Advantages of the Invention

The dynamic label arrangement device in accordance with the present invention can reduce the number of labels whose positions are to be changed per frame, and maintain their readability.

### BRIEF DESCRIPTION OF THE FIGURES

FIG. 1 is a structural diagram of a dynamic label arrangement device in accordance with Embodiment 1 of the present invention;

FIG. 2 is a diagram showing an example of the recorded contents of a first label DB;

FIG. 3 is a diagram showing an example of the recorded contents of a second label DB;

FIG. 4 is a diagram showing an example of the recorded contents of a display information DB;

FIG. 5 is a structural diagram of a position calculator in accordance with Embodiment 1 of the present invention;

FIG. 6 is a flow chart explaining the operation of the dynamic label arrangement device in accordance with Embodiment 1 of the present invention;

FIG. 7 is a diagram showing the position of a display area;

FIG. 8 is a diagram showing an example in which offsets are defined against upper, lower, left, and right sides, respectively;

FIG. 9 is a diagram showing the position of a label 3 in a display screen coordinate system;

FIG. 10 is a diagram showing an example in which candidate points are generated at equal intervals on a road;

FIG. 11 is a diagram showing a positional relationship between labels 1 and 2 and a display screen;

FIG. 12 is a diagram showing a display screen when the display area is moved in the next frame after the labels 1 and 2 have been displayed;

FIG. 13 is a diagram showing an example of the recorded contents of the first label DB after a position change has been performed;

FIG. 14 is a diagram showing a display screen when the display area is moved;

FIG. 15 is a diagram showing an example in which perspective transformation is performed on labels in a 3D map;

FIG. 16 is a diagram showing an example of an arrangement change range in the case of separately defining upper side, lower side, left side, and right side offsets in a 3D map;

FIG. 17 is a structural diagram of a dynamic label arrangement installation in accordance with Embodiment 2 of the present invention;

FIG. 18 is a structural diagram of a position calculator in accordance with Embodiment 2 of the present invention;

FIG. 19 is a flow chart explaining the operation of the dynamic label arrangement device in accordance with Embodiment 2 of the present invention;

FIG. 20 is a diagram showing an outline of a navigation system in accordance with Embodiment 3;

FIG. 21 is a diagram showing an example in which labels each consisting of a character string are displayed at fixed positions by using a conventional map display function;

FIG. 22 is a diagram showing an example in which a label display method as disclosed as a conventional technique is executed at a standard frame rate ranging from 10 fps to 60 fps in a car navigation system; and

FIG. 23 is a diagram showing an example in which a three-dimensional map is displayed by using a conventional map display function.

### EMBODIMENTS OF THE INVENTION

Hereafter, the preferred embodiments of the present invention will be explained in detail with reference to the drawings.

### Embodiment 1

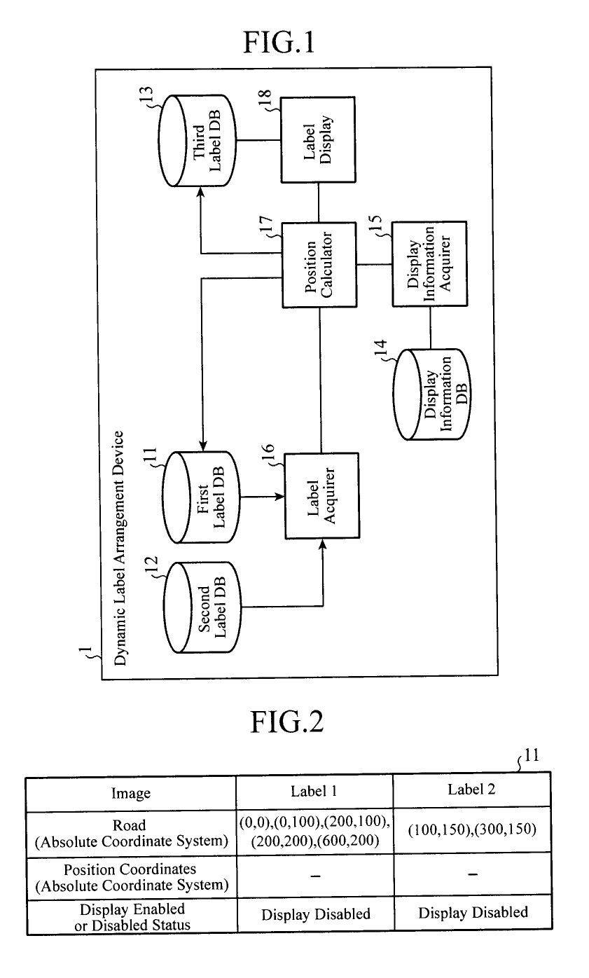

FIG. 1 is a structural diagram of a dynamic label arrangement device 1 in accordance with Embodiment 1 of the present invention.

The dynamic label arrangement device 1 is provided with a first label DB 11, a second label DB 12, a third label DB 13, a display information DB 14, a display information acquirer 15, a label acquirer 16, a position calculator 17, and a label display 18.

FIG. 2 is a diagram showing an example of the recorded contents of the first label DB 11.

The first label DB 11 stores a set of labels, such as road labels and river labels, each of whose position can be changed according to a change of a display area. As shown in FIG. 2, in the first label DB 11, an image (label) to be displayed, a road, position coordinates (in an absolute coordinate system), and a display enable or disable status are recorded for each of the labels. The road accompanying each of the labels, among these items, shows a range in which the position of the label is changed. Although in this example, a road is provided as a range in which the position of a label is changed, an object showing a specific range other than a road can be provided. In Embodiment 1 of the present invention, an explanation will be made assuming that a label is arranged somewhere on each road.

The position coordinates show the center position of the label. Although the center position of the label is defined as the position coordinates in this Embodiment 1, the position coordinates can alternatively show another specific position of the label, such as an upper left corner, a lower left corner, an upper right corner, or a lower right corner.

The absolute coordinate system is a coordinate system in which one point on a map is defined as the point of origin.

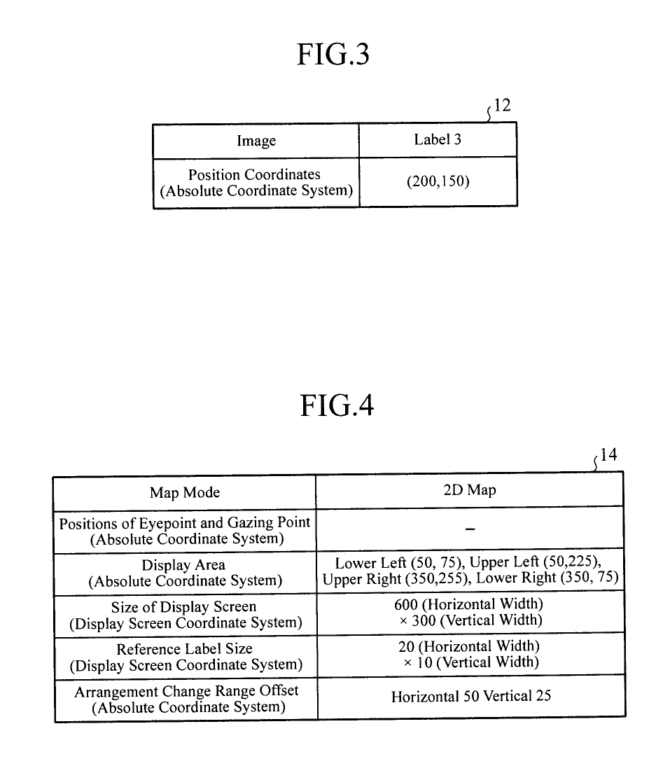

FIG. 3 is a diagram showing an example of the recorded contents of the second label DB 12.

The second label DB 12 stores a set of labels, such as intersection labels and building labels, each of whose position is not allowed to be changed. As shown in FIG. 3, in the second label DB 12, an image (label) to be displayed and position coordinates (in the absolute coordinate system) are recorded for each of the labels. It is assumed that each label stored in the first label DB 11 must not overlap each label stored in the second label DB 12.

The third label DB 13 is a temporary buffer that manages a set of labels to be displayed. In the third label DB 13, an image (label) to be displayed and position coordinates (in a display screen coordinate system) are recorded for each of the labels.

The display screen coordinate system is a coordinate system of a screen to be displayed.

FIG. 4 is a diagram showing an example of the recorded contents of the display information DB 14.

Information required for display of labels is stored in the display information DB 14. Concretely, a map mode, the positions (in the absolute coordinate system) of an eyepoint and a gazing point, the display area (in the absolute coordinate system), the size (in the display screen coordinate system) of the display screen, a reference label size (in the display screen coordinate system), and arrangement change range offsets (in the absolute coordinate system) are stored.

The reference label size shows the size of each label. Although it is assumed hereafter that the size of every label is the same, the size can be different according to each label. When the size is different according to each label, the label size is stored for each of the labels stored in the first label DB11 and in the second label DB 12.

The map mode shows 2D map or 3D map, and, in the case of 2D map, the positions of the eyepoint and the gazing point do not have to be stored.

The arrangement change range offsets define a range, in the display area, in which labels can be arranged, and show a vertical width and a horizontal width offset from the display area. These arrangement change range offsets define a range which is disposed in such a way as to prevent each label from being cut off and becoming hard to see as a result of being arranged at an end of the display area.

The display information acquirer 15 acquires the information stored in the display information DB 14.

The label acquirer 16 acquires the recorded contents of the first label DB 11 and the recorded contents of the second label DB 12.

The position calculator 17 specifies labels to be displayed on the display screen from among the labels stored in the first label DB, and the labels stored in the second label DB on the basis of the recorded contents of the first and second label DBs which are acquired by the label acquirer 16 and the contents of the display information DB 14 which are acquired by the display information acquirer 15, and registers the labels specified thereby in the third label DB. As to labels whose positions need to be changed, the position calculator performs label rearrangement.

The label display 18 displays the labels stored in the third label DB 13 on the display screen.

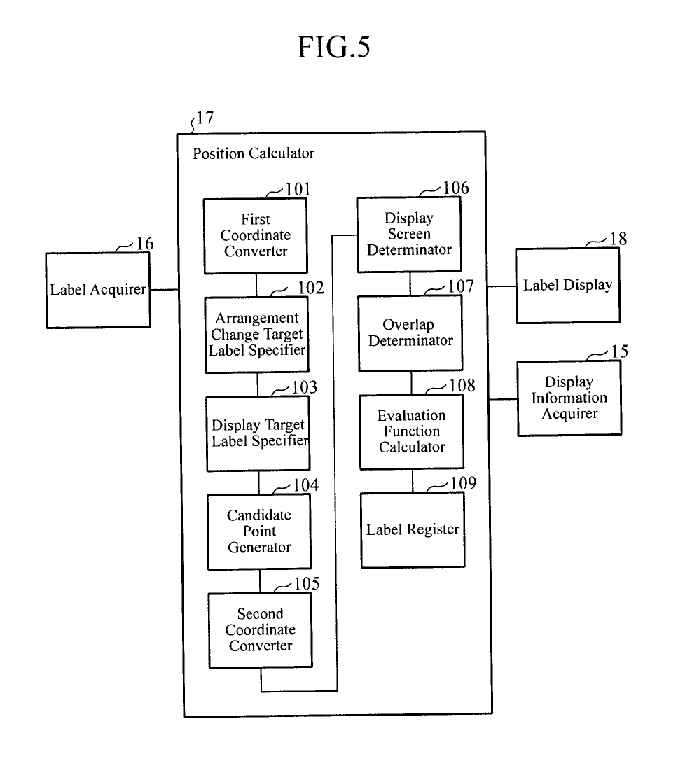

FIG. 5 is a structural diagram of the position calculator 17 in accordance with Embodiment 1 of the present invention.

The position calculator 17 is configured with a first coordinate converter 101, an arrangement change target label specifier 102, a display target label specifier 103, a candidate point generator 104, a second coordinate converter 105, a display screen determinator 106, an overlap determinator 107, an evaluation function calculator 108, and a label register 109.

The first coordinate converter 101 calculates the position coordinates (in the display screen coordinate system) of each of the labels stored in the second label DB 12. When the map mode is 2D, the first coordinate converter performs coordinate transformation for 2D maps, whereas when the map mode is 3D, the first coordinate converter performs coordinate transformation for 3D maps.

The arrangement change target label specifier 102 specifies labels each of which is a target for change of arrangement from among the labels stored in the first label DB 11.

The display target label specifier 103 specifies labels each of which is to be displayed without its arrangement being changed from among the labels stored in the first label DB 11.

The candidate point generator 104 calculates arrangement position candidates of a label stored in the first label DB 11 on the basis of the coordinates of the road accompanying the label. When a specific range is added to the label, the candidate point generator may calculate the arrangement position candidates from the specific range.

The second coordinate converter 105 calculates the position coordinates of the label when this label is arranged at each of the candidate points calculated by the candidate point generator 104. Like the first coordinate converter 101, when the map mode is 2D, the second coordinate converter performs coordinate transformation for 2D maps, whereas when the map mode is 3D, the second coordinate converter performs coordinate transformation for 3D maps.

The display screen determinator 106 determines whether or not each of the candidate points calculated by the candidate point generator 104 is included in an arrangement change range.

When a label is arranged at a candidate point calculated by the candidate point generator 104, the overlap determinator 107 performs both determination of whether the label overlaps another label included in the second label DB 12, and determination of whether the label overlaps another label already registered in the third label DB 13. As an alternative, there can be an example in which both or either of the determination of whether the label overlaps another label included in the second label DB 12, and the determination of whether the label overlaps another label already registered in the third label DB 13 is performed. As an alternative, there can be an example in which no overlap determination is performed.

The evaluation function calculator 108 calculates a function of evaluating the readability of a label.

The label register 109 registers information about a label in the first label DB 11 and the third label DB 13.

Next, the operation of the dynamic label arrangement device 1 in accordance with Embodiment 1 of the present invention will be explained.

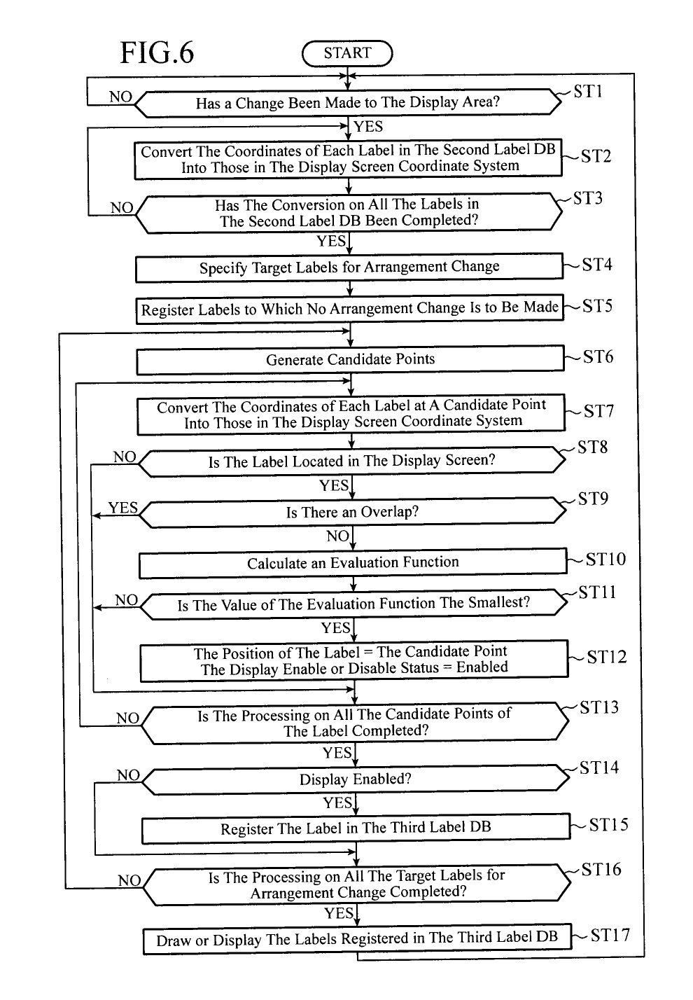

FIG. 6 is a flow chart explaining the operation of the dynamic label arrangement device 1 in accordance with Embodiment 1 of the present invention.

It is assumed that the contents as shown in FIGS. 2 to 4 are stored in the first label DB 11, the second label DB 12, and the display information DB 14, respectively.

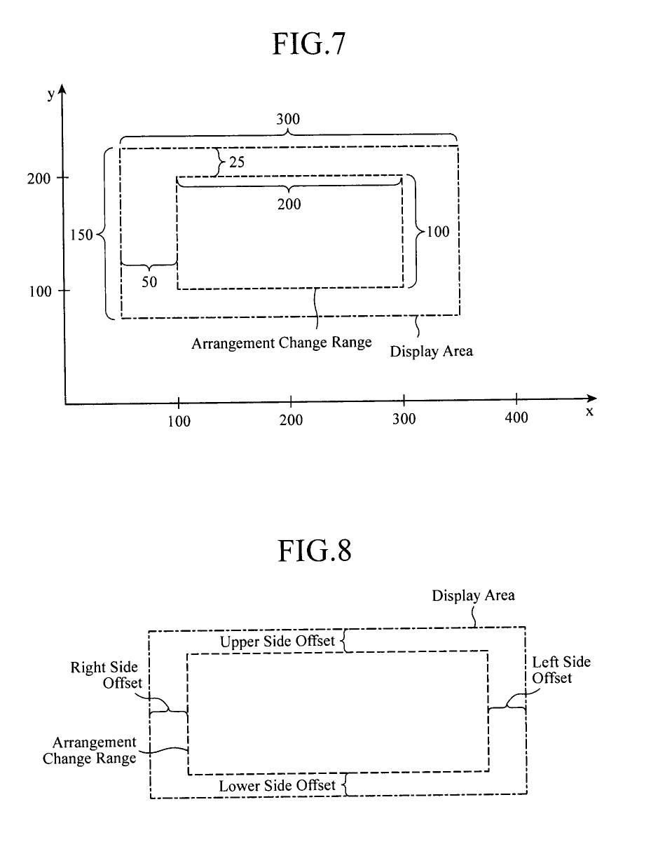

FIG. 7 is a diagram showing the position of the display area (in the absolute coordinate system).

The arrangement change range is determined by the arrangement change range offsets (in the absolute coordinate system) and the display area (refer to FIG. 4), which are recorded in the display information DB.

Although in this Embodiment 1 the offsets of the arrangement change range are expressed in the absolute coordinate system, the offsets of the arrangement change range can be alternatively defined in the display screen coordinate system. As an alternative, instead of the arrangement change range offsets, an arrangement change range in the display screen coordinate system can be defined and used. In these cases, when performing a setting of the position of each label which will be explained hereafter, after converting the position of the label into that in the display screen coordinate system, whether or not the position is included in the arrangement change range is determined.

Further, as the offsets of the arrangement change range, instead of defining the horizontal and vertical offsets, offsets can be defined against the upper, lower, left, and right sides, respectively (refer to FIG. 8). In this Embodiment 1, for the sake of simplicity, it is assumed that the horizontal and vertical offsets are defined, and the vertical offset is used as each of upper side and lower side offsets and the horizontal offset is used as each of right and left side offsets.

First, the display information acquirer 15 acquires the information stored in the display information DB 14, and the arrangement change target label specifier 102 of the position calculator 17 determines whether a change has been performed on the display area from the contents acquired by the display information acquirer 15 (step ST1).

When no change has been performed on the display area (when “NO” in step ST1), the display information acquirer repeats this processing until the display area is changed. More specifically, because when the display area is changed, there is a possibility that some labels are no longer displayed, the dynamic label arrangement device newly resets the arrangement position of each label. Hereafter, an explanation will be made assuming that it is determined from the contents of the display information DB 14 shown in FIG. 4 that a change has been performed on the display area.

When a change has been performed on the display area (when “YES” in step ST1), the first coordinate converter 101 of the position calculator 17 receives the information about each of the labels stored in the second label DB 12 from the label acquirer 16, and converts the position coordinates (in the absolute coordinate system) of each of the received labels into those in the display screen coordinate system (step ST2). A transformation equation from the absolute coordinate system to the display screen coordinate system is as shown in the following equation (1).

(x, y) in the equation (1) show the label position in the absolute coordinate system, and (Tₓ, T_{y}) in the equation (1) show the position of the point of origin of the display screen coordinate system, in the absolute coordinate system. Further, (Sₓ, S_{y}) show ratios between the absolute coordinate system and the display screen coordinate system, and show the horizontal width of the display area (in the display screen coordinate system)/the horizontal width of the display area (in the absolute coordinate system), and the vertical width of the display area (in the display screen coordinate system)/the vertical width of the display area (in the absolute coordinate system), respectively. (x′, y′) show the position coordinates in the display screen coordinate system. The equation (1) is the transformation equation in a case in which the absolute coordinate system is defined with its lower left corner being the point of origin and the display screen coordinate system is defined with its upper left corner being the point of origin.

$$( \begin{matrix}{x}^{′} \\ {y}^{′} \\ 1\end{matrix} ) = ( \begin{matrix}1 & 0 & 0 \\ 0 & 1 & 0 \\ - {T}_{x} & - {T}_{y} & 1\end{matrix} ) ( \begin{matrix}{S}_{x} & 0 & 0 \\ 0 & {S}_{y} & 0 \\ 0 & 0 & 1\end{matrix} ) ( \begin{matrix}1 & 0 & 0 \\ 0 & - 1 & 0 \\ 0 & 0 & 1\end{matrix} ) ( \begin{matrix}x \\ y \\ 1\end{matrix} ) \qquad ( 1 )$$

In the case of the label 3 shown in FIG. 3, because (x, y)=(200, 150), (Tₓ, T_{y})=(50, 225), and (Sₓ, S_{y})=(600/300, 300/150), the position of the label 3 in the display screen coordinate system is (200, 100).

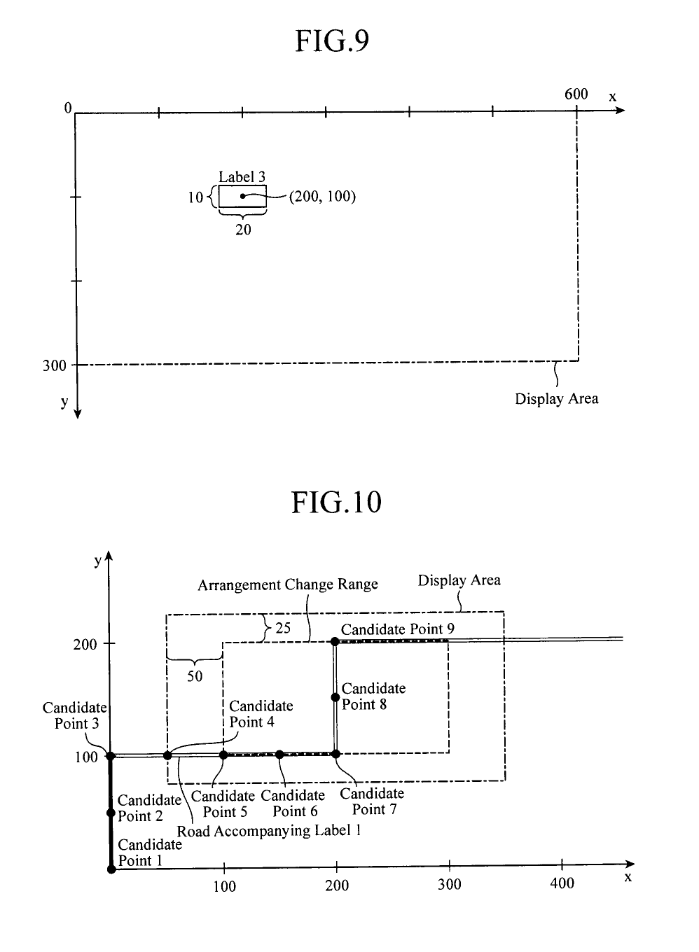

FIG. 9 is a diagram showing the position of the label 3 in the display screen coordinate system.

The first coordinate converter 101 determines whether or not the coordinate transformation on all the labels which the label acquirer 16 acquires from the second label DB 12 is completed (step ST3).

When the coordinate transformation on all the labels is not completed (when “NO” in step ST3), the first coordinate converter returns to the process of step ST2.

When the coordinate transformation on all the labels in the second label DB 12 is completed (when “YES” in step ST3), the arrangement change target label specifier 102 of the position calculator 17 receives the information about each of the labels stored in the first label DB11 from the label acquirer 16, and specifies labels each of whose arrangement position is to be changed from among the labels received thereby, i.e., target labels for arrangement change (step ST4).

Concretely, the arrangement change target label specifier 102 specifies, as labels each of whose arrangement position is to be changed, labels each of which satisfies either of the following two criteria.

(Criterion 1)

A label whose status is display disabled

(Criterion 2)

A label whose status is display enabled and which is located outside the arrangement change range

When a label satisfies the criterion 2, because there is a possibility that the label is not displayed in the current frame, the status of the label is changed to display disabled.

As shown in FIG. 2, both the label 1 and the label 2 which are stored in the first label DB 11 are specified as target labels for arrangement change because their statuses are both display disabled.

When the arrangement change target label specifier 102, in step ST4, specifies target labels for arrangement, the display target label specifier 103 of the position calculator 17 specifies labels which are to be displayed without their arrangements being changed from among the labels acquired from the label acquirer 16 and stored in the first label DB 11, and registers the labels specified thereby in the third label DB 13 (step ST5). Concretely, the display target label specifier specifies labels whose statuses are display enabled and which are located in the arrangement change range, and registers the labels in the third label DB 13. More specifically, a label which it is determined, in step ST4, does not satisfy both the criterion 1 and the criterion 2 does not have to be subjected to a change of its arrangement position, and is registered in the third label DB 13 just as it is, with its status being display enabled.

Because a label in the display screen coordinate system is registered in the third label DB 13, position coordinates on which coordinate transformation into the display screen coordinate system is performed by the first coordinate converter 101 are registered. As a coordinate transformation method for use in the first coordinate converter 101, the same method as that shown in step ST2 is used.

The example shown in FIG. 2 does not have any label which is a target of step ST5 and whose arrangement position does not have to be changed.

Next, the dynamic label arrangement device performs a process of changing the positions of the target labels for arrangement change which are specified in step ST4 one by one.

First, the candidate point generator 104 of the position calculator 17 generates arrangement candidate points of the label 1 of FIG. 2 which are placed at regular intervals on the road (step ST6). Concretely, the candidate point generator generates candidate points at intervals of 50 from the road accompanying the label 1 of FIG. 2. As a result, candidate points 1 to 9 are generated, as shown in FIG. 10. Although candidate points are generated at equal intervals on the road in this embodiment, candidate points can be alternatively generated biasedly in a specific range.

The second coordinate converter 105 of the position calculator 17 converts the coordinates of the label 1 at the time when the label 1 is placed at each candidate point from those in the absolute coordinate system to those in the display screen coordinate system (step ST7). As a coordinate transformation method, the same method as that which the first coordinate converter 101 executes in step ST2 is used.

The display screen determinator 106 of the position calculator 17 determines whether or not the label placed, in step ST6, at a candidate point is included in the arrangement change range (step ST8).

When it is determined in step ST8 that the label is not included in the arrangement change range (when “NO” in step ST8), the dynamic label arrangement device jumps to a process of step ST13. For example, when the label 1 is placed at any of the candidate points 1 to 4 of FIG. 10, because the label is not located in the arrangement change range, processes of steps ST9 to ST12 are skipped.

When it is determined in step ST8 that the label is included in the arrangement change range (when “YES” in step ST8), the overlap determinator 107 of the position calculator 17 performs an overlap determining process (step ST9). It is assumed that the overlap determinator in accordance with this Embodiment 1 performs determination of whether or not there is an overlap between the candidate point of the label 1 and a label stored in the second label DB 12.

When it is determined in step ST9 that there is an overlap (when “YES” in step ST9), the dynamic label arrangement device jumps to the process of step ST13. For example, because the label 1 overlaps the label 3 (200, 150) when the label 1 is placed at the candidate point 8 (200, 150) shown in FIG. 10 (refer to FIG. 8), the dynamic label arrangement device passes the processes of steps ST10 to ST12.

When it is determined in step ST9 that there is no overlap (when “NO” in step ST9), the dynamic label arrangement device advances to the process of step ST10. For example, when the label 1 is placed at any of the candidate points 5 to 7 and 9 of FIG. 10, the dynamic label arrangement device advances to step ST10 because the label 1 does not overlap any other label.

Although in this Embodiment 1 the overlap determinator performs the overlap determination in the absolute coordinate system with the center position of each label being placed at a candidate point, the overlap determinator can perform the overlap determination by using, instead of the center position of each label, the coordinates of the four corners of each label (for example, a case in which when all the four corners of a label are located outside the display area, it is determined that the label is located outside the display area). In that case, as shown in FIG. 4, when the horizontal width and the vertical width of each label are provided in the display screen coordinate system, what is necessary is just to perform the overlap determination in the display screen coordinate system on the basis of the candidate points of the label position whose coordinates are converted into those in the display screen coordinate system in step ST7, and the coordinates in the display screen coordinate system of the four corners of the label. It is needless to say that when the horizontal width and the vertical width of each label are acquired in the absolute coordinate system, the overlap determinator can perform the overlap determination at the center of the label and at the four corners of the label in the absolute coordinate system.

The evaluation function calculator 108 of the position calculator 17 calculates an evaluation function of evaluating the readability of a label (step ST10). In this Embodiment 1, the evaluation function is defined by the following equation (2). Although the evaluation function can be set up as appropriate, because when a label has become displaced outside the arrangement change range due to a movement of the display area, the position of the label must be changed again (this process will be described below), it is desirable that the evaluation function is defined in such a way as that its value decreases when the label is placed in the vicinity of the display center, like that given by the equation (2).

p in the equation (2) denotes the position of the candidate point (in the display screen coordinate system), and q denotes the center of the arrangement change range (in the display screen coordinate system). ∥ ∥ shows the L2 norm.

f(p,q)=∥p−q∥ (2)

The evaluation function calculator 108 determines whether or not the value of the evaluation function calculated in step ST10 is the smallest among the values calculated for the candidate points of the label 1 (step ST11). Although the position which provides the smallest value of the evaluation function is adopted in this Embodiment 1, the position which provides the largest value of the evaluation function can be alternatively used depending on the definition of the evaluation function.

When it is determined in step ST11 that the value is not the smallest (when “NO” in step ST11), the dynamic label arrangement device advances to step ST13.

In contrast, when it is determined in step ST11 that the value is the smallest (when “YES” in step ST11), the label register 109 of the position calculator 17 registers the coordinates of the candidate point in the position coordinates (absolute coordinate system) of the label stored in the first label DB 11, and updates its display enabled or disabled status to display enabled (step ST12).

Next, the candidate point generator 104 of the position calculator 17 determines whether or not the processing on all the candidate points of the label 1 is completed (step ST13).

When it is determined in step ST13 that the processing on all the candidate points of the label 1 is not completed (when “NO” in step ST13), the dynamic label arrangement device returns to step ST7 and repeats the subsequent processes on the other candidate points which have not been processed yet.

In contrast, when it is determined in step ST13 that the processing on all the candidate points of the label 1 is completed (when “YES” in step ST13), the dynamic label arrangement device advances to step ST14.

In this case, for example, when the value of the evaluation function is determined in step ST10 by using the equation (2), the value of the evaluation function is 50√15 at the time when the label is arranged at the candidate point 5 of FIG. 10, the value of the evaluation function is 50√2 at the time when the label is arranged at the candidate point 6 of FIG. 10, and the value of the evaluation function is 50 at the time when the label is arranged at each of the candidate points 7 and 9 of FIG. 10.

In this case, the value of the evaluation function which is determined at the time when the label 1 is arranged at each of the candidate points 7 and 9 is the smallest. When the evaluation function has the smallest value at the two positions, as mentioned above, either one of the positions can be adopted as the position of the label. Hereafter, it is assumed that the candidate point 7 is adopted.

The position of the candidate point 7 is (200, 100) when it is expressed in the absolute coordinate system, and is (200, 200) when it is expressed in the display screen coordinate system. Therefore, in step ST12, the position coordinates of the label 1 stored in the first label DB 11 are changed to (200, 100), and its display enabled or disabled status is changed from display disabled to display enabled.

Returning to the explanation of the operation, the label register 109 determines whether or not the display enabled or disabled status of the label 1 stored in the first label DB 11 is display enabled (step ST14).

When, in step ST13, determining that the display enabled or disabled status is display enabled (when “YES” in step ST14), the label register 109 registers the image of the label 1 and its position (200, 200) in the display screen coordinate system in the third label DB 13 (step ST15).

In contrast, when, in step ST13, determining that the display enabled or disabled status is display disabled (when “NO” in step ST13), the label register skips the process of step ST15.

The arrangement change target label specifier 102 determines whether the processing on all the target labels for arrangement change specified in step ST4 is completed (step ST16).

When it is determined in step ST16 that the processing on all the target labels for arrangement change is not completed (when “NO” in step ST16), the dynamic label arrangement device returns to step ST6 and also registers the remaining labels in the third label DB 13 in the same way. In this embodiment, after the position on which an arrangement change is performed is calculated also for the label 2, like in the case of the label 1, the position coordinates (in the absolute coordinate system) of the label 2 stored in the first label DB 11 are changed to (150, 150) and its display enabled or disabled status is changed to display enabled. Further, the image of the label 2 and its position (100, 100) in the display screen coordinate system are registered in the third label DB 13. The dynamic label arrangement device repeats the processes of steps ST6 to ST16 in this way, and performs the process of changing the label position on all the target labels for arrangement change.

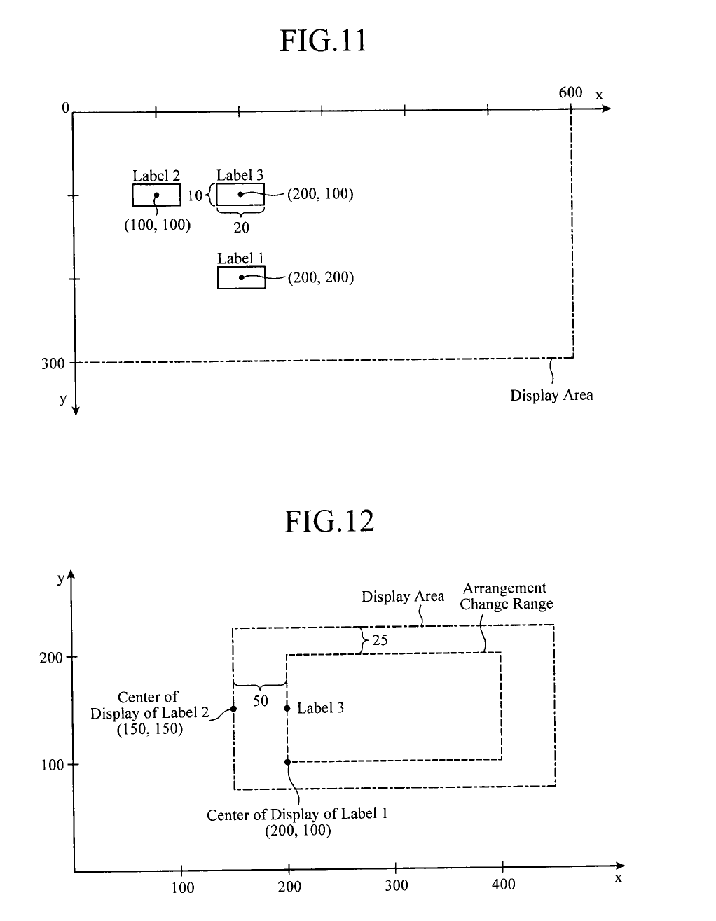

In contrast, when it is determined in step ST16 that the processing on all the target labels for arrangement change is completed (when “YES” in step ST16), the label display 18 performs drawing or display of the labels registered in the third label DB 13 (step ST17). A positional relationship between the labels 1 and 2 and the display screen is as shown in FIG. 11.

After the label display 18 displays all the labels stored in the third label DB 13, the information about the labels stored in the third label DB 13 becomes unnecessary. Therefore, the label display 18 deletes all the labels stored in the third label DB 13.

The dynamic label arrangement device displays the labels on the display screen in the above-mentioned way.

Next, an operation at the time when the display area is moved in the next frame as shown in FIG. 12 after displaying the labels 1 and 2 as shown in FIG. 11 will be explained.

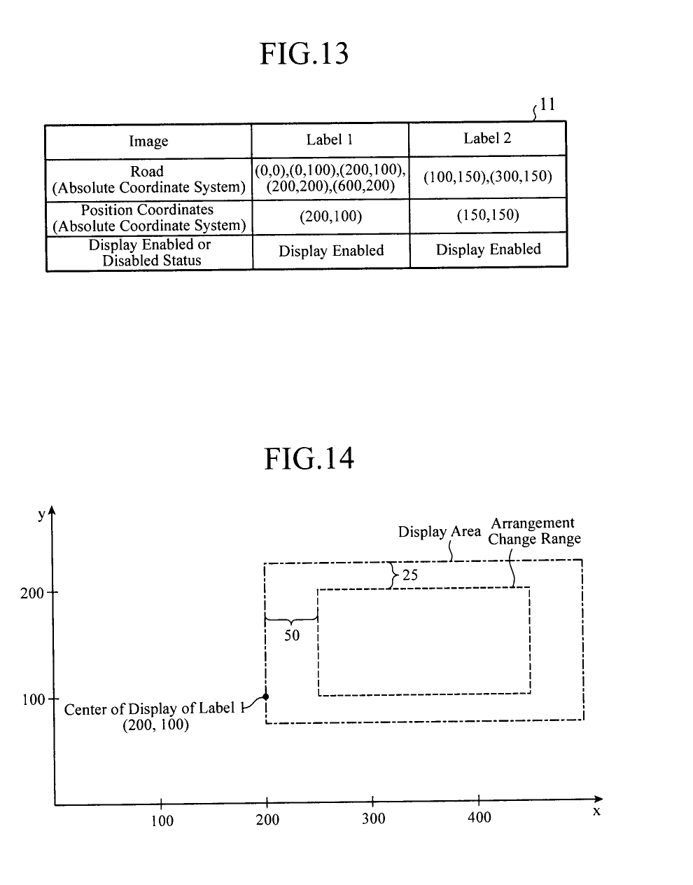

First, the label acquirer 16 acquires the labels 1 and 2 included in the first label DB 11, and the label 3 included in the second label DB 12. The position coordinates and the display enabled or disabled statuses of the labels 1 and 2 are changed to the statuses shown in FIG. 13, respectively, through the above-mentioned position changing process.

In this case, it is determined that a change has been performed on the display area (step ST1 of FIG. 6), the first coordinate converter 101 of the position calculator 17 converts the position coordinates of the label 3 (refer to FIG. 3) from those in the absolute coordinate system to those in the display screen coordinate system (step ST2 of FIG. 6). The coordinates after conversion are (0, 100).

Although the arrangement change target label specifier 102 of the position calculator 17, in step ST4, specifies labels whose arrangements are to be changed (step ST4 of FIG. 6), a relationship among the display area, the arrangement change range, and the centers of display of the labels 1 and 2 are as shown in FIG. 12. At that time, because the label 2 is located outside the arrangement change range, the arrangement change target label specifier 102 specifies the label 2 as a target label for arrangement change.

In contrast, because the label 1 is located within the arrangement change range, the arrangement change target label specifier does not specify the label as a target label for arrangement change and registers this label in the third label DB 13 (step ST5 of FIG. 6).

The position calculator 17 recalculates the position of the label 2 which is specified as a target for arrangement change, to perform an arrangement change on the label (steps ST6 to ST16 of FIG. 6).

The label display 18 then draws or displays the labels 1 and 2 whose arrangement positions have been determined (step ST17).

When the display area is further moved in the next frame as shown in FIG. 14, the label 1 which was located in the arrangement change range immediately before has become displaced outside the arrangement change range. When a label has become displaced outside the arrangement change range in this way, the position calculator changes the arrangement position of the label by using the above-mentioned method.

Although in the above-mentioned example the case in which the map is a 2D one whose map mode stored in the display information DB 14 is 2D is shown, also in a case in which the map is a 3D one whose map mode stored in the display information DB 14 is 3D, arrangement of labels is performed by using the same configuration as that of the dynamic label arrangement device 1 shown in FIG. 1.

However, the coordinate transformation method differs from that in the case of a 2D map.

In the case of a 3D map, the coordinate transformation method is implemented by using a method of performing perspective transformation on a label on the basis of the position of the label, the positions of the eyepoint and the gazing point, and the size of the display screen.

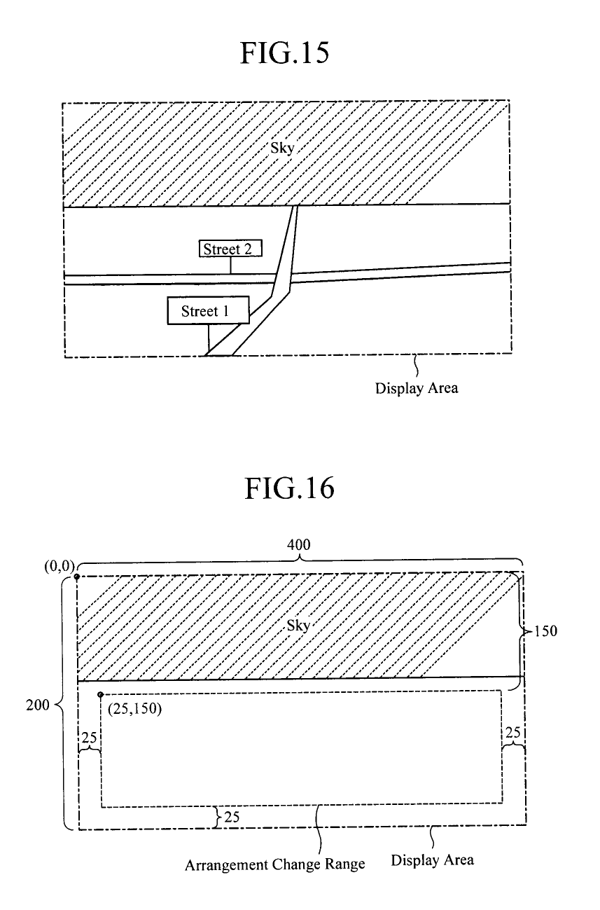

In addition, according to the method of setting the arrangement change range offset, when perspective transformation is performed on labels in a 3D map, a part of the display screen expresses the sky, as shown in FIG. 15. The arrangement change offset can be determined on the basis of the range of the sky. In this case, it is preferable to separately define the upper side, lower side, left side, and right side offsets. For example, assuming that the size of the display area is 400×200 and the upper side, lower side, left side, and right side offsets (in the display screen coordinate system) are 150, 25, 25, and 25, respectively, the arrangement change range becomes such a one as shown in FIG. 16. Because the size of the sky differs according to the setting of the eyepoint and the gazing point, the arrangement change range offset can be changed according to the eyepoint and the gazing point.

As mentioned above, because even if the display area is changed, the dynamic label arrangement device in accordance with Embodiment 1 of the present invention changes the positions of only labels which have become displaced outside the arrangement change range, thereby reducing the number of targets for position change per frame, the dynamic label arrangement device can prevent a flicker of a label due to a position change.

### Embodiment 2

In this Embodiment 2, an embodiment that displays a specific label on a priority basis will be explained.

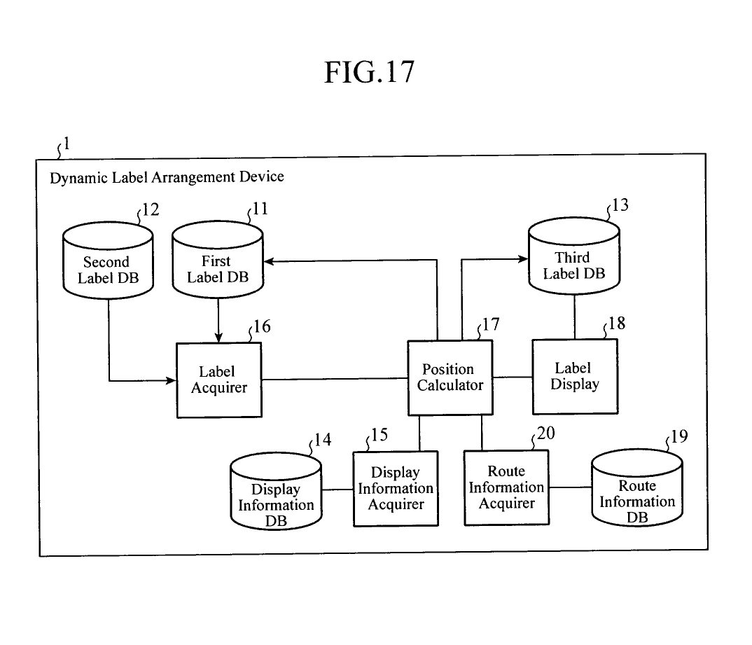

FIG. 17 is a structural diagram of a dynamic label arrangement installation 1 in accordance with Embodiment 2 of the present invention. A duplicated explanation of the same configuration as that explained in Embodiment 1 will be omitted hereafter. The dynamic label arrangement device 1 in accordance with Embodiment 2 differs from the dynamic label arrangement device 1 in accordance with Embodiment 1 in that the dynamic label arrangement device further includes a route information DB 19 and a route information acquirer 20 in addition to the components of the dynamic label arrangement device 1 in accordance with Embodiment 1.

The route information DB 19 stores information about a route from a current position to a destination specified by a user.

The route information acquirer 20 acquires the route to the destination from the route information DB 19.

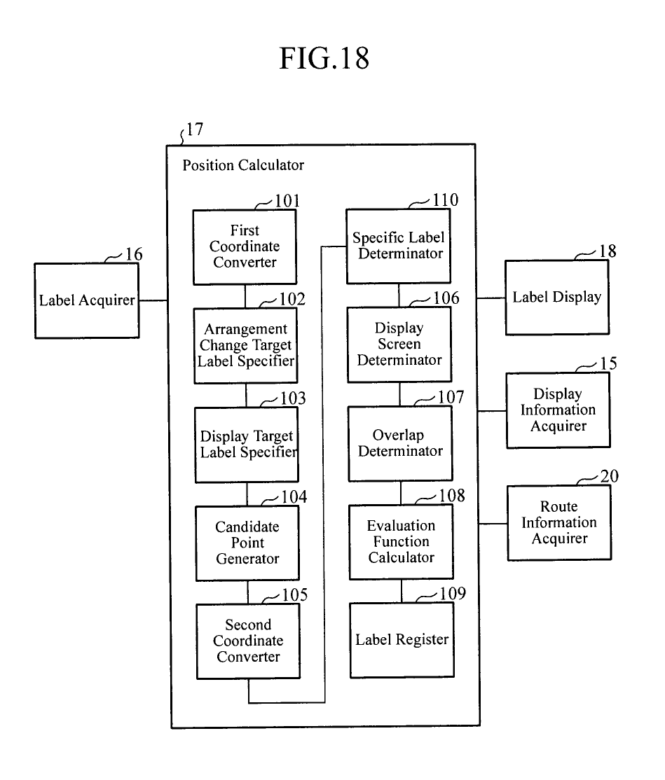

FIG. 18 is a structural diagram of a position calculator 17 in accordance with Embodiment 2 of the present invention.

A duplicated explanation of the same configuration as that explained in Embodiment 1 will be omitted hereafter. The position calculator 17 in accordance with Embodiment 2 differs from the position calculator 17 in accordance with Embodiment 1 in that the position calculator 17 further includes a specific label determinator 110 in the position calculator 17 in accordance with Embodiment 1.

The specific label determinator 110 determines a specific label.

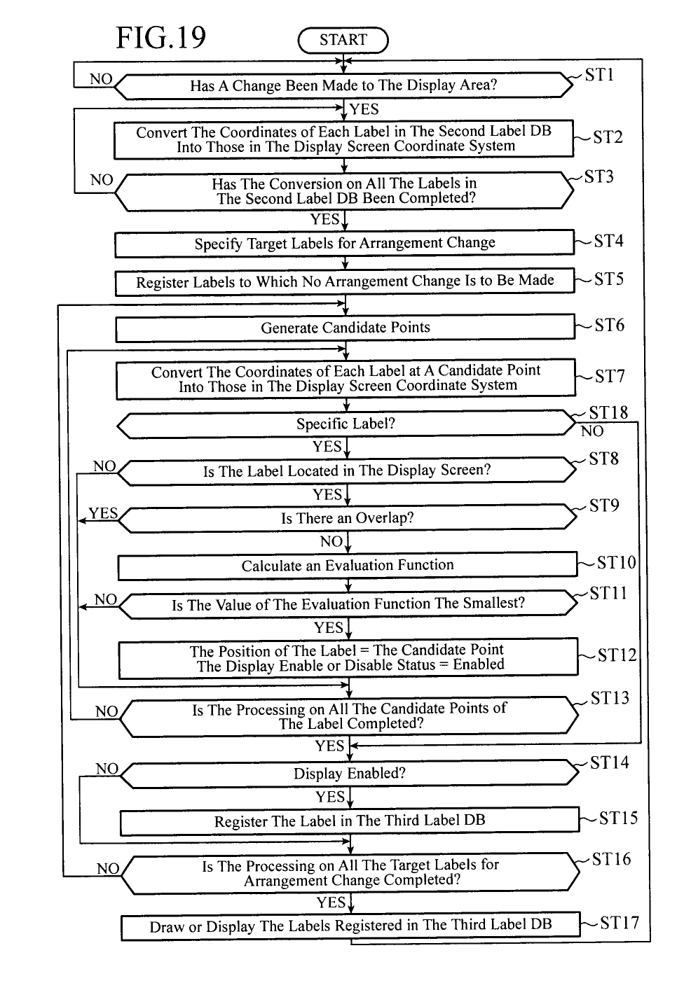

FIG. 19 is a flow chart explaining the operation of the dynamic label arrangement device 1 in accordance with Embodiment 2 of the present invention.

Because steps ST1 to ST17 of FIG. 19 are the same as the steps ST1 to ST17 of FIG. 6 explained in Embodiment 1, a duplicated explanation of the steps will be omitted hereafter and only a part different from the operation shown in FIG. 6 will be explained.

When a second coordinate converter 105 of the position calculator 17, in step ST7, converts the position of a label at the time of arranging the label at each candidate point from that in an absolute coordinate system to that in a display screen coordinate system, the specific label determinator 110 of the position calculator 17 determines whether or not the label is a specific label (step ST18).

Concretely, the specific label determinator 110 determines whether or not a label is a specific label on the basis of the following criteria 3 and 4.

(Criterion 3)

the label is located in the vicinity of the route which the route information acquirer 20 acquires from the route information DB 19.

(Criterion 4)

the label does not overlap a model of a building.

It is assumed that as to “the vicinity of the route” of the criterion 3, the distance between the route and the label is calculated, and a predetermined arbitrary distance is set for the calculated distance.

Further, it can be determined that the label is a specific label when either of the criteria 3 and 4 is satisfied, or it can be determined that the label is a specific label when both of the criteria 3 and 4 are satisfied.

When it is determined in step ST18 that the label is a specific label (when “YES” in step ST18), the dynamic label arrangement device advances to processes of step ST8 and subsequent steps.

In contrast, when it is determined in step ST18 that the label is not a specific label (when “NO” in step ST18), the dynamic label arrangement device skips the processes of steps ST8 to ST13 and advances to step ST14.

At that time, the specific label determinator 110 sets the display enabled or disabled status in the first label DB 11 in which the corresponding label is stored to display disabled.

As mentioned above, because the dynamic label arrangement device in accordance with Embodiment 2 of the present invention gives a higher priority to specific labels and displays these labels, the number of targets for position change per frame can be further reduced and a flicker of a label due to a position change can be further prevented.

### Embodiment 3

Although in above Embodiments 1 and 2, the example of applying the dynamic label arrangement device in accordance with the present invention to a car navigation system is explained, the application of the dynamic label arrangement device is not limited to a navigation device in a car navigation system, and the dynamic label arrangement device can be applied to a navigation device for an moving object including a person, a vehicle, a railroad, a ship, or an airplane, and can be applied to a server in a navigation system. Further, the dynamic label arrangement device can be applied to any form of system, such as a navigation system application or the like which is installed in a mobile information terminal, such as a smart phone, a tablet PC, or a mobile phone, or the like.

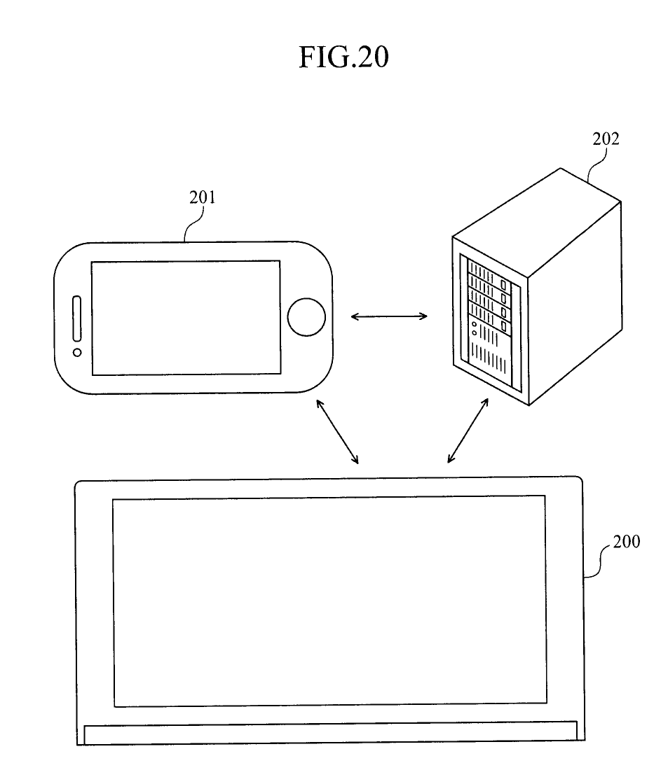

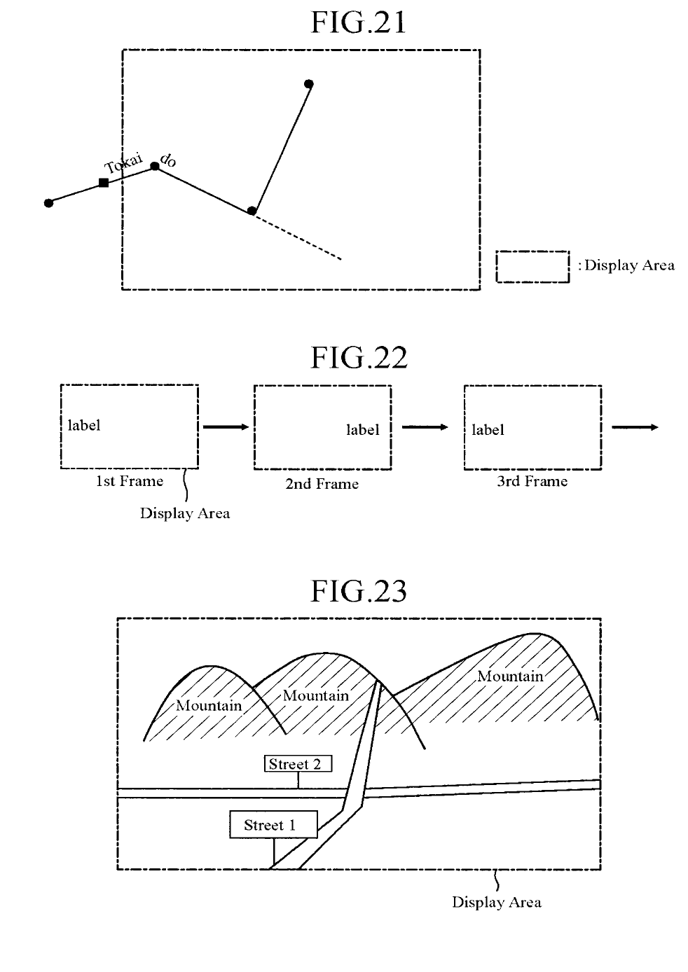

FIG. 20 is a diagram showing an outline of a navigation system in accordance with Embodiment 3 of the present invention. This navigation system can have various forms including a form in which a vehicle-mounted device 200 performs a dynamic label arrangement process and a navigation process in cooperation with at least one of a mobile information terminal 201, such as a smart phone, and a server 202, and a form in which at least one of a mobile information terminal 201, such as a smart phone, and a server 202 performs a dynamic label arrangement process and a navigation process, and displays label information on a vehicle-mounted device 200. Hereafter, the configuration of this navigation system will be explained.

As to the navigation system in accordance with this Embodiment 3, forms excluding the form in which the vehicle-mounted device 200 shown in FIG. 20 is provided with all of the functions of the dynamic label arrangement device in accordance with either of Embodiments 1 and 2, but including the form in which the server 202 performs a dynamic label arrangement process and displays results of the dynamic label arrangement on the vehicle-mounted device 200 to provide the results for the user, and the form in which the mobile information terminal 201 performs a dynamic label arrangement process in cooperation with the server 202, and displays results of the dynamic label arrangement on the vehicle-mounted device 200 to provide the results for the user will be explained.

First, the form in which the server 202 performs a dynamic label arrangement process and displays results of the dynamic label arrangement on the vehicle-mounted device 200, more specifically, the form in which the vehicle-mounted device 200 functions as a display device in cooperation with the server 202 having a dynamic label arrangement function will be explained.

In this configuration, there can be a case in which the vehicle-mounted device 200 communicates directly with the server 202, or a case in which the vehicle-mounted device 200 communicates with the server 202 via the mobile information terminal 201. The server 202 functions as a dynamic label arrangement device provided with first, second, and third label DBs 11 to 13, a label acquirer 16, a display information DB 14, a display information acquirer 15, and a position calculator 17, which are explained in above-mentioned Embodiments 1 and 2. Further, the vehicle-mounted device 200 functions as a display device provided with at least a label display 18 to provide the user with the dynamic label arrangement results provided by the server 202.

In this case, the vehicle-mounted device 200 has only a communication function and a display function basically, and receives the dynamic label arrangement results provided by the server 202 and provides the results for the user.

More specifically, the server 202 is the dynamic label arrangement device provided with the first, second, and third label DBs 11 to 13, the label acquirer 16, the display information DB 14, the display information acquirer 15, and the position calculator 17, and the server 202 which is this dynamic label arrangement device displays the generated dynamic label arrangement results on the vehicle-mounted device 200 which is the display device.

Even in the case in which the navigation system is configured in this way, the navigation system can provide the same advantages as those provided by Embodiment 1 or 2.

The first, second, third label DBs 11 to 13 and the display information DB 14 can be disposed in the server 202, or can be disposed outside the server 202.

Further, the form in which the mobile information terminal 201 performs a dynamic label arrangement process in cooperation with the server 202, and the vehicle-mounted device 200 provides dynamic label arrangement results for the user will be explained.

In this configuration, there can be a case in which the vehicle-mounted device 200 communicates with the server 202 via the mobile information terminal 201, and an application of the mobile information terminal 201 performs a dynamic label arrangement process in cooperation with the server 202. Further, the vehicle-mounted device 200 functions as a display device provided with at least a label display 18 to provide the dynamic label arrangement results provided by the mobile information terminal 201 and the server 202 for the user.

Also in this case, the vehicle-mounted device 200 has only a communication function and a display function basically, and receives the dynamic label arrangement results which are provided the mobile information terminal 201 and the server 202 operating in cooperation with each other, and provides the dynamic label arrangement results for the user.

More specifically, the application of the mobile information terminal 201 displays the generated dynamic label arrangement results on the vehicle-mounted device 200 which is the display device.

Even in the case in which the navigation system is configured in this way, the navigation system can provide the same advantages as those provided by Embodiments 1 and 2.

While the invention has been described in its preferred embodiments, it is to be understood that an arbitrary combination of two or more of the above-mentioned embodiments can be made, various changes can be made in an arbitrary component in accordance with any one of the above-mentioned embodiments, and an arbitrary component in accordance with any one of the above-mentioned embodiments can be omitted within the scope of the invention.

### INDUSTRIAL APPLICABILITY

Because even if the display area is changed, the dynamic label arrangement device in accordance with the present invention can reduce the number of targets for position change per frame and prevent a flicker of a label due to a position change by changing the positions of only labels which have become displaced outside the arrangement change range, the dynamic label arrangement device can be applied to a three-dimensional display map, such as a map for use in car navigation.

### EXPLANATIONS OF REFERENCE NUMERALS

1 dynamic label arrangement device, 11 first label DB, 12 second label DB, 13 third label DB, 14 display information DB, 15 display information acquirer, 16 label acquirer, 17 position calculator, 18 label display, 19 route information DB, 20 route information acquirer, 101 first coordinate converter, 102 arrangement change target label specifier, 103 display target label specifier, 104 candidate point generator, 105 second coordinate converter, 106 display screen determinator, 107 overlap determinator, 108 evaluation function calculator, 109 label register, 110 specific label determinator, 200 vehicle-mounted device, 201 mobile information terminal, and 202 server.

1. A dynamic label arrangement device comprising:
a label DB to store a set of labels;
a display information DB to store information required for display of labels;
a position calculator to specify a label to be displayed on a display screen from among the labels stored in said label DB; and
a label display to display the label specified by said position calculator, wherein said position calculator determines an arrangeable range in which labels can be arranged on a basis of an arrangement change range offset stored in said display information DB, and, when a range of said display screen is changed, performs an arrangement change on a label which has become displaced outside said arrangeable range and which is stored in said label DB.

2. The dynamic label arrangement device according to claim 1, wherein said position calculator includes: an arrangement change target label specifier to specify that a label which has become displaced outside said arrangeable range is a target label for arrangement change; a candidate point generator to generate candidate positions for a destination of arrangement change of said target label for arrangement change which is specified by said arrangement change target label specifier; an evaluation function calculator to calculate an evaluation function of evaluating readability of a label, and decide a position to which arrangement of the label which has become displayed outside said arrangeable range is to be changed; and a label register to register the position which is decided by said evaluation function calculator and to which the arrangement of said label is to be changed in said label DB.

3. The dynamic label arrangement device according to claim 1, wherein at a time of 3D display, said dynamic label arrangement device changes a value of said arrangement change range offset stored in said display information DB according to a position and a size of sky to be displayed on said display screen.

4. A dynamic label arrangement device comprising:
a label DB to store a set of labels;
a display information DB to store information required for display of labels;
a route information DB to store information about a route from a current position to a destination specified by a user;
a position calculator to specify a label to be displayed on a display screen from among the labels stored in said label DB; and
a label display to display the label specified by said position calculator, wherein said position calculator determines an arrangeable range in which labels can be arranged on a basis of an arrangement change range offset stored in said display information DB, and, when a range of said display screen is changed, performs an arrangement change on a label which has become displaced outside said arrangeable range and which is stored in said label DB, and specifies a label to be displayed on said display screen from among the label on which said arrangement change is performed on a basis of the route acquired from said route information DB.

5. The dynamic label arrangement device according to claim 4, wherein said position calculator includes: an arrangement change target label specifier to specify that a label which has become displaced outside said arrangeable range is a target label for arrangement change; a candidate point generator to generate candidate positions for a destination of arrangement change of said target label for arrangement change which is specified by said arrangement change target label specifier; a specific label determinator to specify a candidate position at a predetermined distance or less from the route acquired from said route information DB from among said candidate positions generated by said candidate point generator; an evaluation function calculator to calculate an evaluation function of evaluating readability of a label for each of the candidate positions specified by said specific label determinator, and decide a position to which arrangement of the label which has become displayed outside said arrangeable range is to be changed; and a label register to register the position which is decided by said evaluation function calculator and to which the arrangement of said label is to be changed in said label DB.

6. The dynamic label arrangement device according to claim 4, wherein said position calculator includes: an arrangement change target label specifier to determine the arrangeable range which enables arrangement of labels on a basis of the arrangement change range offset stored in said display information DB, and specify that a label which has become displaced outside said arrangeable range is a target label for arrangement change; a candidate point generator to generate candidate positions for a destination of arrangement change of said target label for arrangement change which is specified by said arrangement change target label specifier; a specific label determinator to specify candidate positions each of which does not overlap display of a building from among said candidate positions generated by said candidate point generator; an evaluation function calculator to calculate an evaluation function of evaluating readability of a label for each of the candidate positions specified by said specific label determinator, and decide a position to which arrangement of the label which has become displayed outside said arrangeable range is to be changed; and a label register to register the position which is decided by said evaluation function calculator and to which the arrangement of said label is to be changed in said label DB.

7. A dynamic label arrangement device that arranges labels on an on-screen map and displays them on a display device, said dynamic label arrangement device comprising:
a label DB to store a set of labels;
a display information DB to store information required for display of labels;
a position calculator to specify a label to be displayed on a display screen from among the labels stored in said label DB; and
a label display to display the label specified by said position calculator, wherein said position calculator determines an arrangeable range in which labels can be arranged on a basis of an arrangement change range offset stored in said display information DB, and, when a range of said display screen is changed, performs an arrangement change on a label which has become displaced outside said arrangeable range and which is stored in said label DB.

8. A display device comprising: the dynamic label arrangement device according to claim 1; and a display to display said label.

9-10. (canceled)
